(19) United States
(12) Patent Application Publication
(10) Pub. No.: US 2006/0106717 A1
(43) Pub. Date: May 18, 2006

(54) End to end check processing from capture to settlement with security and quality assurance

(76) Inventors: William M. Randle, Bexley, OH (US); Randall E. Orkis, Pataskala, OH (US)

Correspondence Address: Edwin M. Baranowski;Porter Wright Morris & Arthur LLP, Suite 3100, 41 South High Street, Columbus, OH, 43215, US

(21) Appl. No.: 10/846,114

(22) Filed: May 15, 2004

Related U.S. Application Data
(63) Continuation-in-part of application No. 10/459,694, filed on Jun. 11, 2003.
(63) Continuation-in-part of application No. 10/283,038, filed on Oct. 25, 2002.
(63) Continuation-in-part of application No. 09/578,329, filed on May 25, 2000, now abandoned.
(63) Continuation-in-part of application No. 10/823,442, filed on Apr. 12, 2004.

(51) Int. Cl. G06Q 40/00

(52) U.S. Cl. 705/45

(57) ABSTRACT

Secure and quality assured electronic end to end check processing from capture to settlement comprising the simultaneous capture of check payment data and an electronic image of the check in which a paper payment instrument is converted into an electronic image and a transaction data file in which image and data file transmission is optimized over a network connection using a data with image to follow protocol dependent upon bandwidth capability and/or criticality of data and at least one of the image and transaction data is quality assured and associated with the data and/or image for use in transmission, settlement, clearing, archive, retrieval and re-presentment by one or a plurality of members on one or more networks.

### RELATED APPLICATIONS

This application is a continuation-in-part of co-pending application Ser. No. 10/823,442, filed on Apr. 12, 2004, Quality Assured Secure and Coordinated Transmission of Separate Image and Data Records Representing a Transaction, which is a continuation-in-part of co-pending application Ser. No. 10/459,694, filed on Jun. 11, 2003, Standardized Transmission and Exchange of Data with Security and Non-Repudiation Functions, a continuation-in-part of application Ser. No. 10/283,038, Dialect Independent Multi Dimensional Integrator Using a Normalized Language Platform and Secure Controlled Access, filed on Oct. 25, 2002, and a continuation-in-part of application Ser. No. 09/578,329, Secure E-Commerce System with Guaranteed Funds and Net Settlement, filed on Feb. 25, 2000, all of which are herein incorporated by reference.

### FIELD OF THE INVENTION

The present invention relates generally to end to end electronic transaction processing, particularly involving financial instruments such as checks, from the capture of transaction data associated with a check and its image at a point of sale or point of presentment, through the truncation of the check and the creation of an IRD, to the ultimate settlement and clearing of a check and the transfer of funds associated with the check transaction in a bank to bank or clearinghouse settlement.

### BACKGROUND AND SUMMARY OF THE INVENTION

Developing the capabilities to revolutionize the payments industry while maintaining cost competitiveness is a major challenge for banks. The lessons learned relative to the events of Sep. 11, 2001, with regards to losing transportation for check clearing, has led to an industry focus directed to electronic means of check presentment with an adequate level of redundancy to avoid single points of failure.

An electronic check clearing system begins with capture (check image and transaction data) at the point of presentment and carries through to clearing and settlement. Making dynamic decisions as to how an item is classified, quality assured (QA) and routed for clearing are the first steps following item capture. Establishing transitive quality assurance early in the process allows others in the processing chain to accept the item and its QA stamp without additional QA, a function that is critical to eliminating additional QA steps as the item moves through the check processing sequence. This is also critical in terms of the transfer of liability associated with the item and associated transaction dispute resolution and overall governance. The use of a dynamic decision engine that can establish item and transaction specific QA is critical to achieving a cost effective solution. This allows the user to define a level of QA (a function dependent on cost and time) that corresponds to the transaction type which may include risk and/or time to settlement as driving factors. For example, a bank may be willing to spend more time and money to QA a high value transaction or a transaction type with a high risk profile than that spent on a low risk or low value transaction. The use of a dynamic engine, which can evaluate criteria about a single payment or set of payments, make decisions regarding the presentment method, and track the movement from capture to settlement, provides a robust capability that has never before been available in the payments industry. Creating a clearing entity that incorporates the value of electronic presentment, access to banks nationwide as well as access to settlement capabilities, exemplifies a best-of-class portfolio. The invention will allow a bank to evolve from a pure paper based processing profile to one based on electronic capture at the first point of presentment, electronic delivery and funding the same and/or next day.

Another area to consider is the identification of fraudulent transactions and moving the “day two” functions of “on-us,” NSF (insufficient funds) and stop payment identification to “day one” functions. Fraud write-offs have shown that verification of presenter and understanding the likely “payability” of a presented check can assist the bank in significantly reducing these write-offs. Consequently, accessing the DDA applications to verify that the account does exist, that funds are available, and accessing stop payment files to see if a match exists, can identify an unacceptable item and allow its return to the presenter in situations such as teller, ATM, commercial back room or retail presentment. This also removes the item from the back office function eliminating the cost of processing that item. This provides an opportunity to collect a fee for this level of validation since the bank may guarantee payment or at a minimum provide a higher level of confidence of this item and optionally ensure the funds remain available by placing a hold on the funds until the posting update that evening.

The components of the invention and the advantages of the system capabilities are described below. Capitalizing on the benefits provided under the Check 21 legislation, banks will need to add new functionality to support electronic check processing at the point of presentment to compliment today's infrastructure that is focused on paper-based payments. The system of the invention describes how an individual bank can use this new technology to take advantage of electronic based clearing mechanisms coupled with enhanced identification and verification services. This may be accomplished over a shared services network that includes a wide range of participants or over a private internal network where the bank supports correspondent banks, retail and commercial customers. With the system of the invention, the bank, and its customers, can capture the data and images associated with clearing items at a much earlier point in the clearing process, truncate the original paper, and move and clear the transaction electronically. This resulting time savings between presentment and settlement provides a fundamental element of fraud reduction that is not possible in today's paper based environments. The ability to confirm an account in real time at the point of presentment for an on-we item provides a further level of fraud detection and reduction that is not possible in today's paper based environment.

An advantage of the invention is the ability of the system to capture, validate and clear transactions rapidly and inexpensively to include the electronic capture of paper items at the point of sale or presentment. To accomplish this, rules are established, based on the preferences of the bank or bank's customer, that allow decisions to be made based on, for example, source, paying bank, QA value, value of item, item type, risk profile of the customer, risk profile of the item, risk profile of the transaction, time of day, best clearing path, or proximity to clearing deadlines. The capture source may be a branch teller, the back counter of a branch for bulk capture, an image-enabled ATM, an image-enabled point of purchase device, or a corporate or correspondent back office. The engine of the system takes these factors into consideration, to make QA and routing decisions to the preferred method of clearing and settlement and logs and uniquely signs the transaction for audit and reference purposes. Options may include activities internal to the bank such as real-time posting to the bank's DDA system, image archive and retrieval, conversion to paper clearing utilizing an IRD, conversion to ACH, fraud detection, electronic payments, and the like.

In addition to the benefits afforded to a single bank, new functions provide value to all participants over a shared multi-function services network (SMFSN) by allowing the sharing and consolidation of functions across participants and banks. One such function is an extension of the “on-us” identification, verification, and posting capabilities between participating member banks. In the SMFSN this is an on-we activity where “on-we” is defined as any group of users on the network. Options over a SMFSN are supported and may include but are not limited to: a request for account verification, image transport, image retrieval, ID validation, User and transaction authentication and authorization, net settlement actions, IRD distribution, request for guarantee, cash orders, and the like.

The invention is described more fully in the following description of the preferred embodiment considered in view of the drawings in which:

### BRIEF DESCRIPTION OF THE SEVERAL VIEWS OF THE DRAWINGS

FIG. 1A is a flow chart showing steps in check processing from presentation, to payment, and return to a customer, an example of the general environment in which the invention is useful.

FIG. 1B is a chart showing the overall system integration capabilities of the system of the invention interconnecting multiple functions, components and processors.

FIG. 2 shows in detail components of the central processing engine used at various points in an overall integrated system such as shown in FIG. 1B.

FIG. 3 is a multiple participant view showing network connections for a shared multi-function services network (SMFSN).

FIG. 4 depicts the shared multi-function services network with image quality assurance (QA). Quality assurance performed at any of the QA identification points shown (designated “QA” with a check mark, QA√) allow an agreed to QA value to be accepted at any point in processing. This establishes a method for transitive QA where the recipient has the option to not do any additional QA if the recipient agrees to the original QA process undertaken by a prior participant in the check flow, using one or more already assigned QA attributes.

FIG. 5 illustrates an information exchange among Banks A, B, C and D (FI network participants) and non-FI network participants, Bank E, exchanges, clearing houses and archives in a shared multi-function services network.

FIGS. 6, 7, 8, 9, 10A, 10B, 11A and 11B illustrate QA process orchestration and flow for QA decisioning with electronic item sorting and routing. This includes QA function definition and flow, QA exception processing definition, QA exception processing flow, and electronic super sorting. The ability to establish virtual electronic processing bins and flows as depicted in the figures allows for an infinite range of QA processes, sorting routines, and exception routing and workflow processes to be established and managed within the system. This supports a broad range of custom QA sorting and routing offerings that are completely user defined. Some examples include: time of day routing for quickest settlement path, multiple levels of QA based on capture artifacts, presenter profile, risk score, transaction value, settlement method, presentment method, presentment location, etc., and multiple exception handling paths based on the results of QA paths. Specifically, FIG. 6 is a flow chart of image capture and QA flow; FIG. 7 depicts an example of a single attribute QA process flow; FIG. 8 shows an example of check processing from capture to distribution through QA routing; FIG. 9A charts QA path processing; FIG. 9B shows pre-stored QA functions and definitions; FIG. 10A charts exception processing functions; FIG. 10B charts exception processing path definitions; FIG. 11A charts super sort routing options; and FIG. 11B charts super sort criteria.

### DETAILED DESCRIPTION OF THE INVENTION

The term “on-we” describes a transaction that is associated with a participating member of the shared multi-function services network, SMFSN, where there is an agreement to share information. Examples of sharing include information to support real-time verification and posting between members. Member relationships may be defined as one to one, one to many, or many to many, and may be among any parties on the SMFSN or to entities that participate in the SMFSN via a member or sponsor participant.

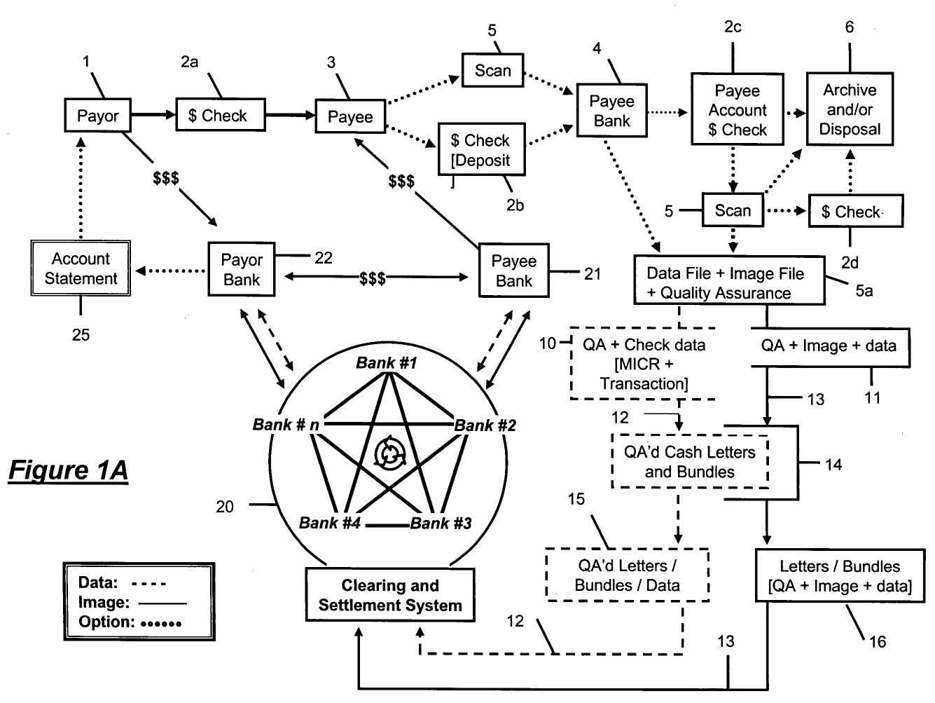

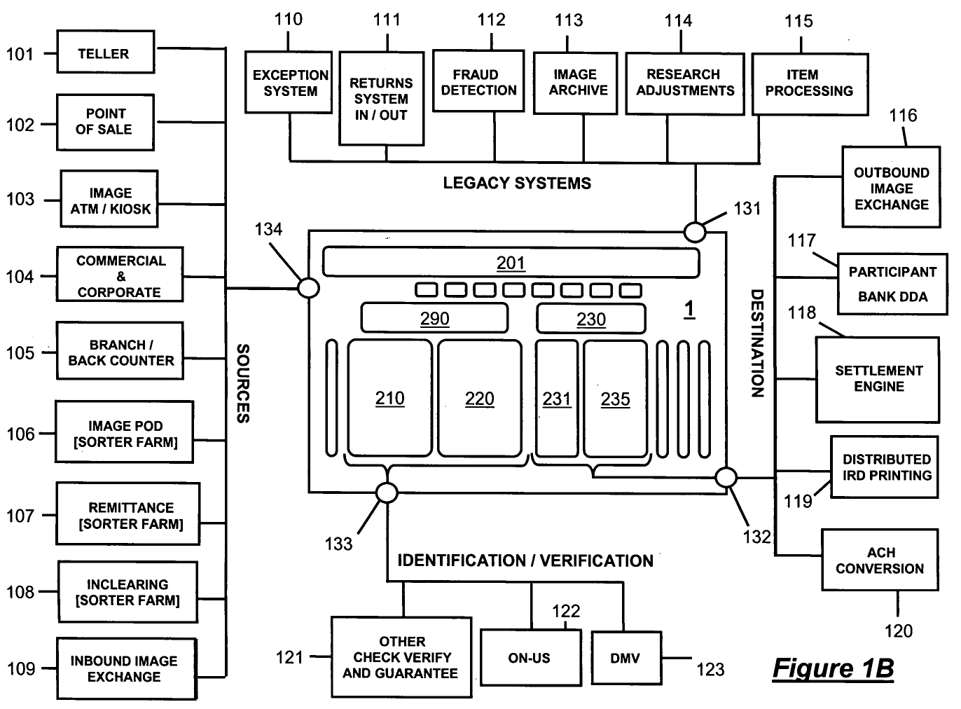

FIG. 1A outlines one example of the processing sequence of a check transaction. As is known, a payor/check writer 1 fills out a check 2a made payable to a payee 3. The check may be a paper instrument that the check writer fills out by hand or an instrument created electronically that is printed and signed. In an embodiment, the check includes a MICR line that encodes the check number, the check writer's bank and the account at the bank upon which the check is drafted. The check writer determines the amount of the check and the payee, enters both on the check, may add additional information (such as what the payment was for), signs the check, and delivers it to the payee. As shown in the options example of FIG. 1A, delivery may be of the physical check to a bank of deposit or by an electronic transmission effected through a scan at the point of sale, a possible QA check mark point.

The payee 3 endorses the check 2b and presents it to a bank of first deposit or the payee's bank 4. The deposit bank 4 captures the check and related information by a scan 5 to create an image of the front and back of the check and collects information such as the payee name, bank, payee's account number, the amount of the check and the MICR data. While “banks” and “checks” are referred to as examples, the scope of the invention encompasses financial institutions and financial instruments involved in a payment system. The captured data and image information is checked for quality and if found insufficient, the transaction is flagged or routed for exception processing. After a scan 5 at whatever stage, the transaction data file and coordinated image and data file and QA checkmark 5a, comprising the QA'd data file 10 and the QA'd image plus data file 11 are separately manipulated and processed for settlement, payment and clearing in the paths shown at 12 and 13. For clearing, cash letters and bundles are prepared 14 and settlement processing proceeds in an image coordinated with data 16 follows data only 15 protocol. Typically, cash letters and bundles are submitted into a clearing house 20 where aggregate funds transfers between and among financial institutions are calculated and ultimately paid. Clearing houses contemplated by the invention are 1) conventional paper based clearing houses where paper and electronic items are commingled and settled and cleared, or 2) clearing houses where a separate channel is made available for electronic items, for example, where instruments are processed as data and image together or in a system where image follows data, separate and apart from the conventional paper based channel. In either instance at the time of clearing and settlement, bank to bank funds balances between and among participating banks are settled for the items cleared. After clearing, the checks (in image or IRD (image replacement document) form) are returned to payor banks 22 where they are separately processed, sorted and associated with individual payor's accounts, and returned, as data and/or a complete or partial image, to the payor in or accompanying an account statement 25. Payee bank 21, receiving funds, will assign the funds represented by the financial instrument and credit the funds to the respective individual payee 3.

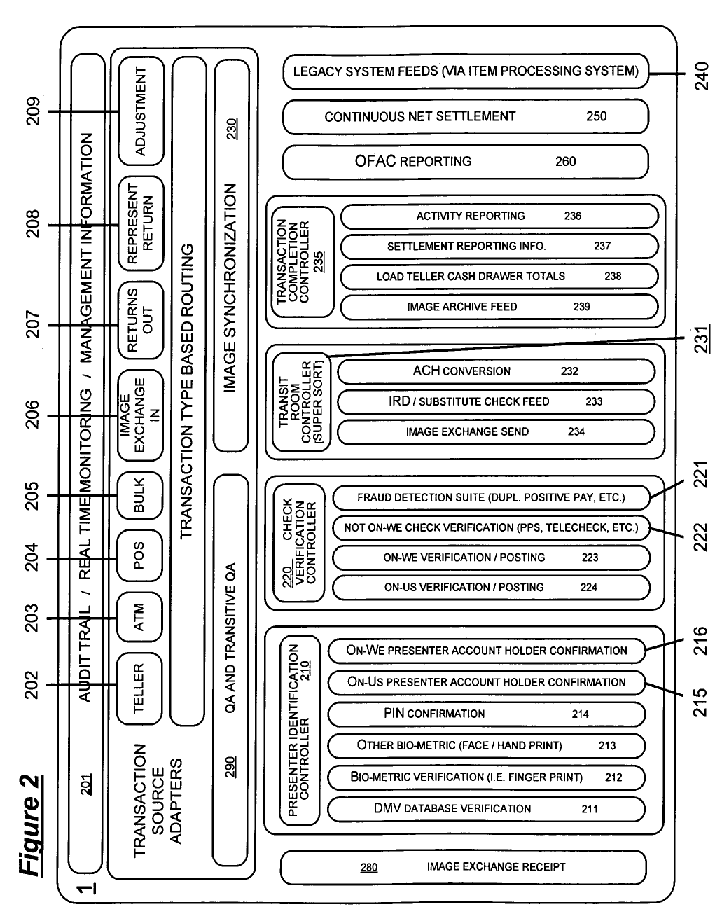

FIG. 1B depicts an outline of the end to end processing of the invention. FIG. 1B is a chart showing the overall integration capabilities of the engine of the invention interconnecting multiple functions, components and processors that perform transaction type based routing after receiving information from various sources, and provide quality assurance and transitive quality assurance and image synchronization functions in the course of processing. In FIG. 1B, central processing engine of the invention 1 is shown interconnected at various points 131, 132, 133, and 134 through the SMFSN or a private network connection with various financial instrument, i.e., check, sources at 134 such as 101 teller, 102 point of sale, 103 image ATM/kiosk, 104 commercial and corporate, 105 branch back counter, 106 image POD (sorter farm), 107 remittance (sorter farm), 108 inclearing (sorter farm), and 109 inbound image exchange. Typically, when a check is presented for payment an indorsement by the successive holders of the check in due course is applied by each consecutive holder; the indorsements represent a payment guarantee by the holder to the next holder. Legacy systems also feed into the engine at point 131 showing connections to: 110 exception processing, 111 returns system (in/out), 112 fraud detection, 113 image archive, 114 research adjustments, and 115 item processing. Optional functionalities, such as a real time continuous net settlement link and a Department of the Treasury Office of Foreign Assets Control look up table may also be built into the engine 1 which is described in further detail with reference to FIG. 2. Destination targets from the engine output at 132 include 116 outbound image exchange, 117 participating bank DDA, 118 a settlement engine such as a clearing house, 119 distributed IRD printing, and 120 ACH conversion. Also interconnected is an identity verification module at 133 that includes 121 other check verify and guarantee, 122 on-us checks, and 123 DMV (Department of Motor Vehicles) or other interconnections for identity inquiries.

The sources, described below, of transactions to which the invention is applicable are categorized as either interactive or bulk capture. Dynamic quality assurance (QA) is performed on the image and the transaction and a QA value is established and associated with the item prior to the acceptance (or further processing in the event of rejection) of the item. Dynamic QA allows the QA to be tailored to the transaction profile. This may include multiple QA paths depending on the profile which may include decisioning based on the level of risk, the profile of the customer, the cost of QA, the presentment method or environment, and the value of the transaction. The assigned QA value moves with the transaction file as the file moves through the process to settlement and clearing. In general, check sources will typically involve identification of the individual, QA inspection and decisioning, as well as the attempted verification of funds for the check being presented. The results of these validation steps are communicated back to the source presenting the check either prior to acceptance of the check or as an adjustment back to the presenter in the case where the presenter is not part of an interactive real time session. The validation activities and results are uniquely associated with the transaction file as the file moves to settlement and clearing.

In the example of a teller accepting a check, check transactions, such as deposits and cashed checks that are presented to a bank teller 101 are scanned at a teller workstation and passed to the engine 1 either directly from the capture device or from the teller system. An interface exists between the system of the invention and the teller platform and/or scanning device. The engine performs identification, QA, and/or verification services and passes the results back to the teller. The teller optionally determines whether or not to cancel, modify, or commit that transaction set. The final decision is communicated back to the engine. Dynamic QA is performed on the image and the transaction and a QA value is established. This QA value moves with the transaction file (which may comprise related data and image segments in most instances) as it moves to settlement and clearing. The engine can accept from the teller or assign a unique identifier (a transaction ID and sequence number) to each component of the transaction and the overall transaction. The engine establishes a digital signature unique to the transaction and each component of the transaction. The invention passes the data and image and the associated digital signature to the central server. The engine processes the data and image for purposes of verification, posting, and logging of any control totals, and ensures that they are matched for downloading to the archive or to any other downstream process that requires the image.

Checks presented at point of sale (POS) 102 are scanned at the point of presentment and passed to the engine along with information to validate the identity of the individual. The POS process may be a multi-step process where the transaction components are scanned and entered at the POS workstation and passed to the engine. The system of the invention performs the identification, QA, and/or verification services and passes the results back to the POS clerk. The clerk determines whether or not to cancel, modify, or commit that transaction set. This decision is communicated back to the engine. Dynamic QA is performed on the image and the transaction and a QA value is established. This QA value moves with the transaction file as it moves to settlement and clearing.

The POS platform may assign a unique identifier (a transaction ID and sequence number) to each component. Upon receipt from the POS, the engine establishes a digital signature unique to the transaction and each component of the transaction and passes the data and image independently to the central solution server. The engine processes the data and image for purposes of verification, posting, and logging of any control totals, and ensures that they are matched for downloading to the archive or to any other downstream process that requires the image.

Checks deposited at an image-enabled ATM or kiosk (ATM) 103 are scanned at the ATM location. An interface exists between the engine and the ATM software so the transaction can be passed from the ATM platform to the system of the invention. The ATM process may be a multi-step process where the transaction components are scanned or entered at the ATM and then passed to the engine after the transaction set is entered and balanced. The engine will perform the validation and/or QA services and pass the results back to the ATM. If any of the deposited checks fail validation, the entire transaction set may be cancelled, the deposited checks can be returned to the presenter, who can be notified as to which checks were rejected via the ATM. If all of the deposited checks pass validation, the transaction is committed by the engine and the depositor is notified accordingly by the ATM. An override function is supported in the event a transaction is rejected, but in this function, the bank nevertheless chooses to assume a risk, such as in the case with a trusted customer.

The ATM platform may assign a unique identifier (a transaction ID and sequence number) to each component and pass this to the engine. Upon receipt from the ATM, the engine establishes a digital signature unique to the transaction and each component of the transaction and passes the data and image independently to the centralized solution server. The invention processes the data and image for purposes of verification, posting, transmission, and logging of any control totals, and ensures that the data involved are matched for downloading to the archive or any other downstream process that requires the image.

Bulk capture sources are used for higher volumes of check presentment and may not involve performing verification prior to physical acceptance of the check from the presenter. Dynamic QA can be performed on the items at the bulk capture point. In general, with bulk capture sources, the data and images are sent to the system of the invention in larger groups, or batches, of checks. As is the case with interactive sources, the checks received from the bulk capture sources are captured, corrected, and balanced prior to being released to the engine. This process does not require simultaneous receipt of the data and images. The data and image may be assigned separate, but associated, unique identifiers by the capture processes and/or the engine and can be sent to the engine independently.

Commercial and corporate capture 104 is a cash management product that the bank can offer to its customers. This involves implementation of an image-scanning device at the customer's location. Scanned, corrected, and balanced work is transmitted to the system of the invention for verification, posting, and clearing purposes as well as for inclusion in the image archive. In this case QA may be performed at the remote capture site, at the receiving side of the system, or at both, depending on the nature of the transaction profile.

Not all deposits presented at the teller are scanned at the teller workstation. For instance, large commercial deposits will be set aside and scanned as a back counter function 105. In this case, the work is not balanced, verified, or posted until some time after the customer has left the teller. Scanned, corrected, and balanced work is transmitted to the system of the invention for verification, posting, and clearing purposes as well as for inclusion in the image archive. In this case dynamic QA may be performed at the back counter capture site, at the receiving side of the system, or at both, depending on the nature of the transaction profile.

The current image proof of deposit process at a sorter farm 106 can be integrated with the system of the invention to accelerate the posting and returns process for any checks that are presented as well as to accelerate the outgoing clearing for checks drawn on other banks. Scanned, corrected, and balanced work can be transmitted to the engine for verification, posting, and clearing purposes as well as for inclusion in the image archive. Dynamic QA can be performed at the POD sorter farm, by the engine, or at both, depending on the nature of the transaction profile.

An image-enabled remittance process at a sorter farm 107 can be integrated with the system of the invention to accelerate the posting and returns process for any items presented as well as to accelerate the outgoing clearing for other items. Included is the ability to convert checks to account receivable conversion (ARC) transactions via the Automated Clearing House (ACH). Dynamic QA is supported as part of this process where QA is performed at the sorter farm, by the engine, or at both, depending on the nature of the transaction profile.

Posting of the in-clearing items received via paper-based in-clearing cash letters can be accelerated along with acceleration of the returns process by interfacing the in-clearing capture process at the sorter farm 108 with the system of the invention. When the code-line details are received by the engine the verification and posting processes can be performed to post transactions online. As part of this process, potential returns such as stop payment suspects can be identified and sent to the bank's exceptions system for review and decisioning and any definite return items, such as stop payment hits can be sent immediately to the bank's returns system.

Inbound image exchange files can be received into the system of the invention as shown at 109 to perform validation of the file, dynamic QA, as well as verification and posting of the associated checks. As above, early initiation of the exceptions and returns processing can be performed. In addition, any posting reject that appears related to a code-line problem, such as account not found, can be routed to the bank's legacy item processing system to be processed via code-line correction.

Depending on the source from which a check is being presented, a series of dynamic QA, identification and verification services can be performed. These services will reduce check losses by checking the identification of the individual presenting the check as well as verifying the check itself. In addition, dynamic QA can be used to establish a transitive QA signature that can move with the item through the processing chain. This allows any recipient to accept this QA signature in lieu of performing another QA process, saving time and money in processing the item.

In other check verification and guarantee applications, for checks presented at a point of sale that are not drawn on a participating bank, the bank will have the option of offering the retailer additional check verification and guarantee services 121 such as those offered in the market today. The system of the invention can interface to these services for real-time verification and/or guarantee.

Verification is performed on “on-us” items through module 122. Examples of the information to be confirmed include: valid account, account standing, valid bank, valid or not a duplicate check number, availability of funds, correct signature, valid positive pay item, and the absence of restrictions such as stop payment orders. When the transaction is committed, either via a confirmation from an individual such as a teller, or automatically via a bulk capture process, the confirmed transactions can also be posted online. As with the interactive sources, when a check is presented at point of sale or to a teller, the identification of the presenting individual can also be performed. If the individual is an account holder at a participating bank, the identification services include access to the bank's core processing systems.

When a check is presented at point of sale or to a teller, the identification of the presenting individual can also be validated. When this identification requires validation of the driver's license or state-issued identification card, the system of the invention can compare the information contained on the ID card to the information from the applicable state's DMV database, or other ID database 123. This may be done online over the SMFSN or offline through a network connection to a system of record maintaining this information.

The engine accesses certain legacy systems to exchange data, either for the process or for updating these systems for subsequent processes, through node 131.

Interface to the bank's exception system 110 is available to accelerate the exception processing including the making of pay/no-pay decisions for any item that is received via a bulk capture process and fails validation. This interface can be used for posting exceptions such as “Stop Pay Suspects” where a review must be performed.

An interface to the bank's inbound and outbound return systems 111 is available to accelerate the outbound returns process for any item that is received via a bulk capture process and fails for any reason that the bank has pre-defined as a “definite return”. This interface 111 is used for posting exceptions such as “Stop Pay Hits” where a review is not required prior to returning the item. Interface to the bank's inbound return system is available to support the receipt of inbound returns via electronic methods such as via image exchange or for item returns. The inbound interface sends the return item as well as the associated image (or an index to the archive) to the inbound returns system. An interface 111 to the bank's inbound return system is available to support the forward presentment of inbound return items that are being re-presented. This interface receives the outbound re-presentment as a bulk capture feed and routes it to the applicable out-clearing destination, such as real-time posting, via a return check (RCK) ACH transaction or via image exchange.

As more transactions are migrated from paper to electronic form, the emphasis on automated fraud detection will increase. As part of the system of the invention, an interface is available to the bank's fraud detection product(s) or to a third party service 112 (via SMFSN) to provide real time and/or bulk review of the items processed.

Before institutions can perform truncation at the point of capture, the institution must be confident that it has captured a quality assured (QA) image and related data for the check and secured that information in a non perishable and secure storage facility or archive 113. The engine supports dynamic QA based on the transaction profile where QA is performed on a captured check image and its related transaction data and the files are digitally signed. Then the option for data reduction is supported on the image for transmission through the check processing chain. In addition, with the acceleration of clearing to the point of real-time posting and the movement of functions historically performed on “day two” to “day one,” the speed at which an image is available in the archive becomes increasingly important. The image archive 113 may be local or accessed via the SMFSN and ensures that images received by the engine are loaded into the archive and that this process can be performed throughout the processing day or in real time as opposed to waiting until the end of the day.

Image data reduction options with QA are supported with QA being available before and after data reduction. The capture of a check in an 8 bit gray scale (or color) high dpi format (100 dpi or 200 dpi) may be needed to assure a high level of quality for a QA process. Once that QA process is completed on the high resolution image (stamped with a QA√ signature; for example, as shown by the “QA√” check marks in the drawings) then the image is converted to a less size intensive format for transmission and use in the check processing chain. The QA signature provides an audit trail for this process and assures QA is not lost as part of the data reduction process. Examples of data reduction include: 1) 8 bit gray scale to bi-tonal (black and white); 2) 200 dpi color to 100 dpi bi-tonal; 3) 100 dpi to 50 dpi bi-tonal, 4) 24 bit color to 8 bit gray scale; 5) 8 bit gray scale to 4 bit gray scale, 6) color (grey scale or full color) to bi-tonal (black and white), and 7) equivalent or similar reductions in tone, color, contrast, resolution or other parameters. Thus the image is captured, QA'd, and then data reduction is performed (keeping the unique digital signature and transitive QA) as a method to reduce file size which increases transmission speed and reduces storage requirements. Data reduction may also include variations in pixel resolution and/or color depth.

Data reduction and image segmentation with QA may also be accomplished. Segmentation of the check image where areas of interest are kept at the higher resolution and the irrelevant or blank areas are converted to a lesser resolution and/or color depth may also be done. Examples of critical information include the signature line, endorsement, amount, payee, and MICR data compared with other areas of the check.

Research and adjustments are two critical “day two” systems that require information about the processing performed by the system of the invention. The research and adjustments systems 114 require all items data to support retrievals and re-creation of transactions as well as endpoint assignments and any other information required to support the re-creation of outgoing cash letters.

A number of interfaces are supplied in the system via the current item processing system. Depending on the bank, these interfaces shown at 115 can include float management, endpoint analysis, fraud and risk detection, general ledger, research and adjustments to name a few. In order to leverage the software that is already in place, an all items interface is supplied from the system of the invention to the item processing system containing the transaction data, but without the associated images. This interface can be used to import data into the check processing and to feed downstream applications.

A value of the system of the invention is the ability to clear transactions rapidly and inexpensively. To accomplish this, rules are established based on the preferences of the bank that allow decisions to be made based on, for example, source, paying bank, value of item, time of day, transaction type, presentment method, QA value, QA method, level of authentication, transaction profile, proximity to clearing deadlines and/or other criteria. The engine of the invention can take these factors into consideration, make dynamic routing decisions to the preferred method of clearing and settlement and log the transaction for reference purposes. These options may include real-time posting to the bank's DDA system for on-us items, image exchange, paper clearing utilizing an IRD, conversion to ACH, presentment to the SMFSN for action and the like. A multitude of “on-we” activities are supported over the SMFSN that focus on fraud reduction as well as speed and cost of settlement and clearing.

With regard to outbound image exchange, the Check 21 legislation is a catalyst for banks to take advantage of image exchange. The system of the invention allows the bank to develop a processing hierarchy and designate checks payable at image enabled banks to be sent via image exchange 116. This includes, for example, through node 132, the ability to send the image and data in a combined file, send the two components separately in an “ECP with image to follow” scenario, or as data only with an index to the image in an “image on request” scenario. The engine supports the transmission of unique signatures for audit and security purposes as well as an item specific transitive QA indicator.

Participating bank DDA or third party identification system allows real-time access to a participating bank's DDA system 117 and adds benefits for identification of the presenting individual, verification of the account associated with a check, and for real-time posting to maximize the verification benefits. Real time access to a third party identification system provides for enhanced identification and reduced identity fraud.

Clearing houses and other settlement engines such as private or Federal Reserve clearing houses can be used for inter-bank settlement between participating member banks or any entity participating in a net settlement activity. This interface 118 consists of the net settlement transactions, which are sent throughout the day to initiate inter-participant settlement. The frequency of these transmissions, and the associated settlement cutoffs, may be real time or based on a predefined schedule that is related to a transaction profile, QA value or method, and/or participant profile. Settlement via a private clearing house is available for participating member banks, which offer real-time sharing of DDA information, as well as member banks. In addition, the clearinghouse can be used for settlement between a participating bank and its correspondent banks. A net settlement entity such as a clearing house can also use the system of the invention to provide clearing and settlement services for client banks. For instance, the bank may supply a clearinghouse with a mixed cash letter that the clearinghouse electronically sorts and clears using the solution's engine on behalf of the member bank or network participant for net settlement of any activity.

The Check 21 legislation authorizes the use of printed substitute checks or image replacement documents (IRD's) to allow a collecting bank (or correspondent bank) to use electronic-based clearing mechanisms to reach non-image-enabled paying banks. The system allows distributed IRD printing. By printing IRD's at a location near the paying bank, transportation costs and clearing fees are reduced and the clearing of these items is accelerated. The system of the invention provides an interface 119 to a distributed IRD printing system to allow for clearing via this method. This interface can be dynamic performing routing and distribution based on one or any of the following: time of day, risk profile, cost, capture and settlement geography, transaction value, cumulative QA, or others.

The system also facilitates ACH conversion through a network interconnection. The National Automated Clearing House Association (NACHA) rules permit certain transactions to be converted to Automated Clearing House (ACH) transactions and processed in accordance with ACH regulations instead of check regulations. This includes: 1) certain check payments presented at a retail point of sale, which can be converted to point of presentment (POP) transactions; 2) certain re-presented returned checks, which can be converted to return check (RCK) transactions; and 3) certain check payments presented to billers via a remittance or lockbox operation; and 4) certain bank loan payments presented over the counter can be converted to accounts receivable conversion (ARC) transactions. Through a portal in the engine, ACH conversions of such items for processing can be accomplished.

The system of the invention also provides the ability for the bank to determine whether to use ACH conversion and which items should be converted and also provides an interface to ACH conversion software to support this conversion. The ACH interface 120 includes support for the ACH conversion software to reject individual items that are not eligible for clearing, such as those drawn on commercial accounts. In the case of a rejected ACH conversion request, the bank also determines the alternate clearing mechanism to use, such as via distributed IRD printing, or other dynamic electronic routing.

The processing engine controller shown in FIG. 2 is central to the invention. The controller is passed transactions from the various transaction sources. Based on the rules for that source, it determines the specific set of business rules for that transaction type and source of work. FIG. 2 is a logical overview of the controller showing in detail the central processing engine 1 controlling the various processing points within the overall system otherwise shown in FIG. 1B. In FIG. 2, the engine 1 provides an audit trail/real time monitoring and management information module 201 with a series of transaction source adapters interconnected with 202 teller, 203 ATM, 204 POS, 205 bulk, 206 image exchange in, 207 returns out, 208 represent return, and 209 adjustment for transaction type based routing. Quality assurance and transitive quality assurance module 290 feeds into presenter identification controller 210 and check verification controller 220. Presenter identification controller includes 211 DMV database verification, 212 bio-metric verification (i.e., finger print), 213, other bio-metric (face, hand print, eye scan, and the like), 214 PIN confirmation, 215 on-us presenter account holder confirmation, and 216 on-we presenter account holder confirmation. Check verification controller 220 includes 221 fraud detection suite (duplicate transactions, positive pay, etc.), 222 not on-we check verification (PPS, TeleCheck™, etc.), 223 on-we verification posting, and 224 on-us verification/posting. Image synchronization module 230 includes 231 transit item controller (super sort) which in turn includes 232 ACH conversion, 233 IRD/substitute check feed, and 234 image exchange send. Image synchronization module 230 also includes 235 transaction completion controller, having modules 236 settlement reporting information, 237 activity reporting, 238 load teller cash drawer totals, and 239 image archive feed, and intake and return feeds to legacy systems 240 (via item processing system), continuous net settlement mechanisms 250, and 260 OFAC (United States Department of the Treasury Office of Foreign Assets Control) look up and reporting. The image exchange receipt node is shown at 280.

Within the controller engine are sets of individual functional controllers that initiate, control, and monitor the various sub-functions that can be performed, such as identification of the presenting individual or verification of the check. These controllers can be initiated independently of each other and simultaneously by the routers. In addition, these controllers call sub-functions to perform specific tasks that can also be initiated independently of each other and simultaneously by the controllers. Thus, a single transaction may initiate the processing of multiple sub-functions simultaneously, maximizing the processing time available within a limited processing window.

An image synchronization task based function 230 is responsible for monitoring the incoming transaction data and image components, matching images received to their data portion, and initiating the applicable functional controllers and sub-functions upon a successful match or in the event that one component, such as the image, is not received within the specified time parameters.

Maintaining a thorough and accurate historical record of the processing performed is a critical component of any financial processing system particularly with high speed online processing. An integral part of the invention engine is thorough logging of the transactions processed in a module included at 201, the functions performed for each transaction and the results of those functions. A transitive QA signature is part of this functionality. Real time monitoring through module 201 is available for multiple aspects of the processing being performed. From a systems support perspective, the transaction volume, transaction processing volume and speed, as well as queue sizes can be monitored by the technical support team. For the bank's treasury management and application balancing teams, real time reporting is available for the number and amount of transactions processed, by source and for each destination endpoint. For “on-us” items processed, totals are reported by application. For “on-we” items processed, totals are reported by destination end point as well as “on-we” defined entities. For clearing items, totals are reported by clearing point with separate settlement related totals reported for pending transactions which have been sent to an endpoint, 1) but are not yet committed, 2) are committed and agreed totals that have not been sent to the clearinghouse for settlement, and 3) settled totals which have been sent to the clearinghouse. The user has the option to define multiple cut off times specific to their need or the needs of a client. Examples may include multiple cut off times based on dollar amount, best settlement path, end point profile, etc. All of these settlement totals are reported separately for debits and credits with separate totals for send and receive. In addition, both separate and consolidated totals are available to reflect correspondent bank activity and corporate and commercial customers. The settlement instructions sent to the clearinghouse are for the net settlement position between the member banks or a defined net settlement user group and activity.

Historic monitoring of volumes and values is an important aspect of clearing mechanisms. The Information available in real time by the engine is also retained in accordance with the bank's retention profiles to support historic reporting and trend analysis as included in 201. This includes detailed breakdowns by department within the bank, for correspondent banks, and for work captured by corporate or commercial clients to support both management information and billing for these areas.

The image exchange receipt process 280 handles the acceptance and validation of inbound image exchange files. This includes files sent from any interconnected clearinghouse or the system of the invention processing network, as well as between participating banks. Once the file has been received and validated, processing is handed off to the image exchange receipt adapter for the applicable paying bank.

The presenter identification controller 210 of the engine is a functional controller that is used to initiate, control, and monitor various sub-functions associated with identification of the individual initiating the transaction. These sub-functions can include “on-us” 215 and “on-we” 216 data lookups and access to the applicable DMV files 211, third party systems, and the storage and retrieval of biometric information such as fingerprints 212 or other biometric data 213 for analysis and comparison. In addition, PIN confirmation 214 is provided.

The check verification controller 220 is a functional controller that is used to initiate, control, and monitor the various sub-functions associated with verification of the check being presented such as fraud detection suite (duplicate transactions, positive pay, etc.) 221, not on-we check verification (PPS, TeleCheck™, etc.) 222, on-we verification posting 223, and on-us verification/posting 224.

A significant improvement provided by the system of the invention is the ability of the transit item controller (super sort) 231 to route transit checks to the most effective clearing mechanism available in accordance to the rules provide by the bank. The transit item controller 231 is a functional controller that is used to initiate, control, and monitor the various sub-functions associated with this clearing and also contains the super sort processing logic to determine the clearing method and assign the endpoint. As indicated previously, in addition to real time posting for checks, transit items can be clearing via image exchange 234, distributed IRD printing 233 or ACH conversion 234.

The transaction completion controller 235 is a functional controller used to initiate, control, and monitor sub-functions associated with completion of a transaction, which is also known as commitment of the transaction. Some of these tasks depend on the receipt and synchronization of the image to the data. Some of the sub-functions include placing the transaction in a queue for loading into the archive, the logging of cash and other application related processing totals, and the logging of settlement related totals. For activities such as the loading of the archive and logging of settlement totals, the sub-functions performed by the transaction completion controller load data into a processing queue for a subsequent task, such as the image archive load or continuous net settlement to act upon. The continuous net settlement function 250 is executed at predefined intervals in accordance with the governance rules for the net settlement entity of interest.

The engine also includes interfaces 240 to the bank's legacy systems including an interface to the item processing system. There is a sub-function for each of these feeds to handle the specific interface requirements of that feed. Other legacy systems that will be using output from the central processing engine are risk, OFAC reporting and other reporting tools.

The system of the invention for multiple participating banks, including clearing house customers, can be integrated to provide a multi-bank interchange platform that significantly expands the benefits available to all involved. This is accomplished via the SMFSN where relationships and activities can be defines as one to one, one to many, or many to many.

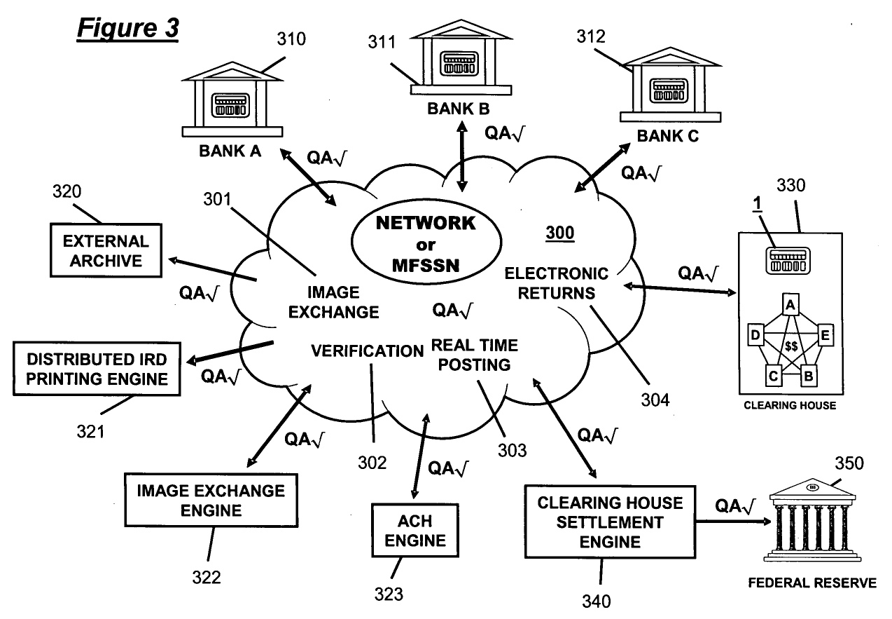

FIG. 3 shows the multi-bank view of these interconnected products. FIG. 3 is a multiple bank view showing a central private network or SMFSN 300 interconnecting the functions 301 image exchange, 302 verification, 303 real time posting, and 304 electronic returns. Bank A 310, Bank B 311 and Banc C 312 are shown as participants in the central engine functions that include 320 external archive, 321 a distributed IRD printing engine, 322 an image exchange engine, 323 an ACH engine, and a private clearing house 330 with participants Bank A, Bank B, Bank C, Bank D and Bank E and a clearing house settlement engine 340 interconnected with the network or SMFSN operating in conjunction with the Federal Reserve 350. Each interconnection includes a quality assurance, QA, functionality which may be either associated with operations of the function or unit or a vicarious quality assurance, based of previous QA accomplished by a prior trusted party.

As shown in FIG. 3, each member bank can be interconnected via a private, SMFSN, or public network with other system functions. This provides enhanced inter-bank clearing capabilities, such as real-time verification and posting across members. In addition to reducing the risk of accepting checks payable at participating members, this opens the door for additional cross-member services, such as cross-member deposit acceptance and check cashing.

This interconnected platform also provides benefits by leveraging common processes such as image exchange, ACH conversion, enhanced ID management, and distributed IRD printing. For instance, a single bank may not have sufficient volume for a distributed IRD endpoint to warrant the creation of a print center in that area. If this volume is combined with the clearing of the other members, this combined volume can be leveraged to justify the cost. Leveraging of volumes across several banks will also aid in reducing individual per unit item costs. This is especially significant when considering the trend is for a declining use in checks, and the forecast for IRD volumes suggest an initial peak followed by a decline once image files become widely accepted. A clearing house may also use the system of the invention to provide services to its member banks that are not direct participants in the network. These customers may or may not support real-time access to their legacy systems and may use the service strictly as a clearing mechanism. For example, a clearinghouse customer can provide the clearinghouse with an all items file or a mixed electronic cash letter and the clearinghouse will electronically route the checks to the most applicable (cost effective, convenient, quickest, etc.) destination for the clearing and settlement of the items for the customer. In addition, the clearinghouse may be the recipient of image exchange files for the customer, either as a direct send or via a mixed electronic cash letter, and will process the items from the various sources, consolidate them, and send them to the customer for posting to their legacy applications. A clearinghouse or other third party entity could use the engine to collect the data to feed a shared image archive that is offered to its customers. Just as a clearing house can offer services to its members via the system of the invention, the participating banks can extend the invention's processing functionalities to its corresponding banks.

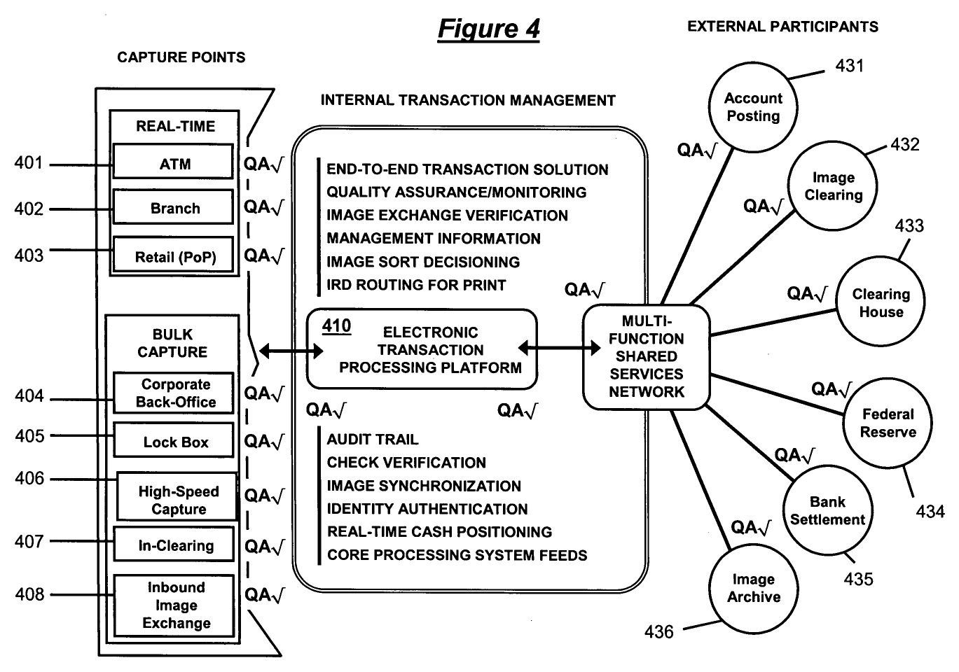

The system of the invention includes a shared multi-function services network, SMFSN, for the secure transmission and retrieval of data among a defined group of participants where each of the participants has the optional ability to secure access to their data in addition to the overall network definition. In addition, each network participant has the ability to define exchange agreements with any other participants on a one to one, one to many, or many to many basis without the knowledge of others that are not part of that relationship but are, nevertheless, part of the network. SMFSN supports use of a public and/or private network infrastructure and includes full encryption in addition to a secure key infrastructure that can be managed in or out of band. For example, FIG. 4 depicts the Shared Multi-Function Services Network with image quality assurance (QA) at all points in the system. QA performed at any of the QA check mark “QA√” identification points shown will allow an agreed to QA signature to be accepted at any other end point. The recipient has the option to not do any additional QA if the recipient agrees to the original QA process using one or more QA attributes. Real time capture points 401 ATM, 402 branch, 403 retail POP (point of purchase), and bulk capture points 404 corporate back-office, 405 lock box, 406 high-speed capture, 407 in-clearing, and 408 inbound image exchange feed into the transaction processing platform of the invention 410 providing an end-to-end transaction processing solution, quality assurance and monitoring, image exchange verification, management information, image sort decisioning, IRD routing for print, an audit trail, check verification, image synchronization, identity authentication, real-time cash positioning, and core processing system feeds. The multi-function share services network 420 feeds the functions 431 account posting, 432 image clearing, 433 clearing house, 434 Federal Reserve, 435 bank settlement, and 436 image archive.

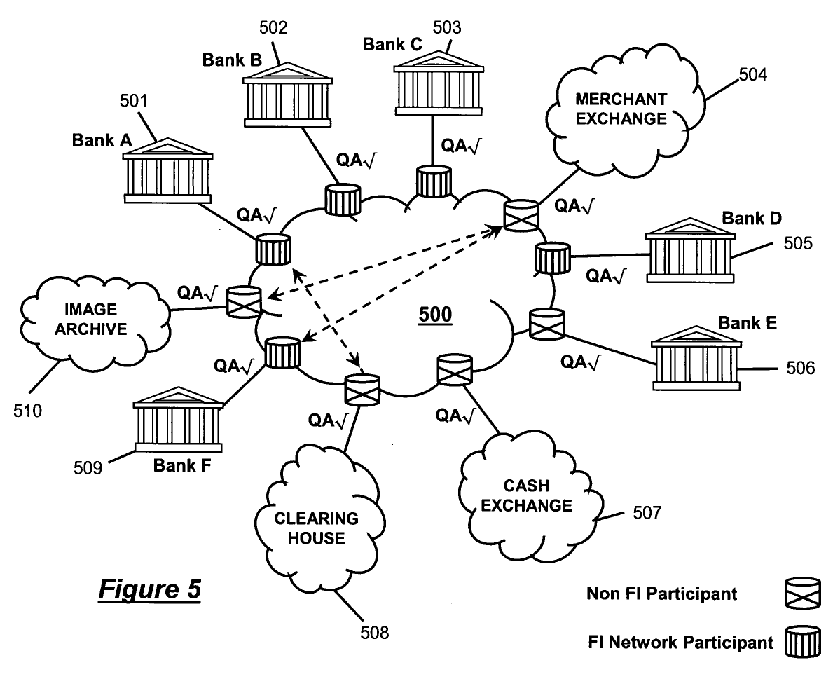

Similarly, participants and non-participants in the system may share benefits. FIG. 5 illustrates an information exchange 500 among subscribing participants Bank A 501, Bank B 502, Bank C 503, Bank D 505 and Bank F 509 and non-subscribing services or institutions such as merchant exchange 504, Bank E 506, cash exchange 507, clearing house 508 and image archive 510, all secured and either in a direct, or a vicarious trusted party, quality assured relationship.

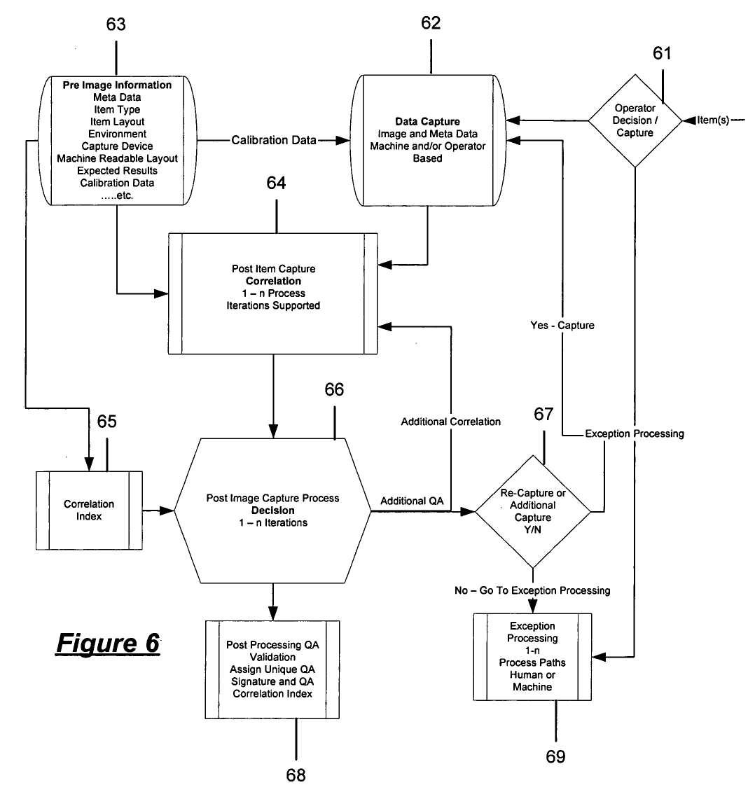

FIG. 6 illustrates image capture QA flow beginning with item receipt and operator decision/capture at 61 followed by 62 data capture, image and meta data which may be machine and/or operator based. Calibration data, such as shown at 63 including pre-image information, meta data, item type, item layout, environment, capture device, machine readable layout, expected results, and other calibration criteria are input with data. At 64, a post item capture correlation is undertaken in a 1-n criteria process with various iterations supported. A correlation index 65 is generated and in the post image capture process 66, a decision based on the 1-n iterations is made determining whether additional quality criteria are required for the item, namely, re-capture or additional capture at 67. Depending on a Y/N determination, post processing and validation will occur and the item will be assigned a unique QA signature and QA correlation index 68. Exception processing in the event of a rejection occurs at 69 and the item passes through the 1-n criteria process paths by either human or machine criteria.

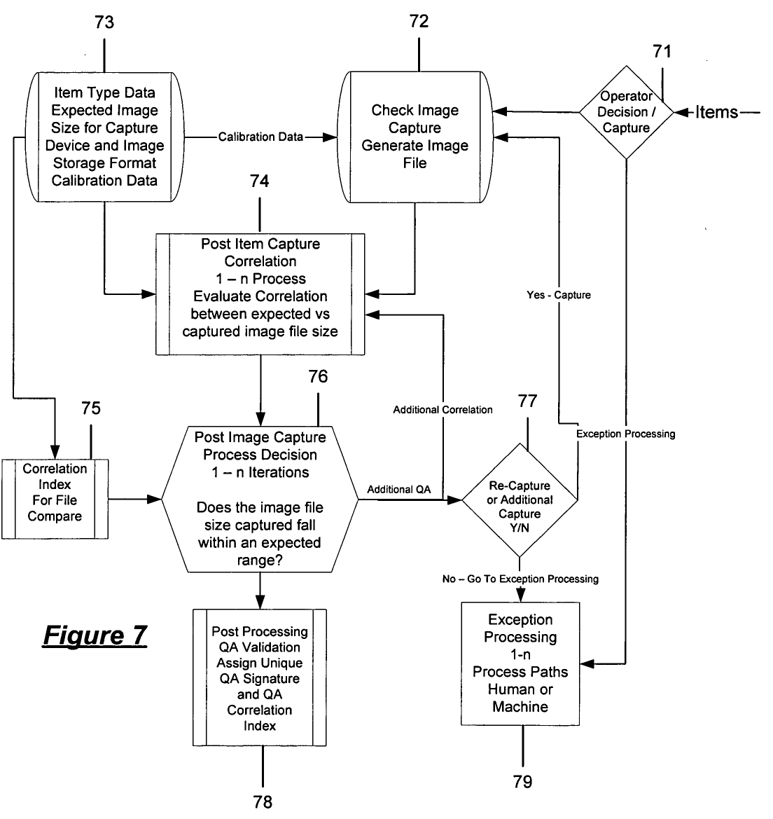

In FIG. 7, a single attribute QA process flow is shown as an example of a system in accordance with FIG. 6. Operator decision/capture occurs at 71, followed by 72 check image capture and the image file is generated. Calibration data at 71 such as item type data, expected image size for capture device and image, storage format, and other calibration data, is assembled and post item capture processing follows at 74 in a criteria correlation 1-n process to evaluate the correlation between expected vs. actual captured image file size using the correlation index 75 for file comparisons. Post image capture process decision is made at 76 in 1-n criteria iterations, for example, by a criterion whether the image file size captured falls within an expected range, or whether designated fields are completed. Re-capture or additional capture 77 may be required depending on the Y/N result of the initial criteria screen. Post processing QA 78 occurs with validation and the assignment of a unique QA signature and QA correlation index to the item processed. Exception processing 79 for 1-n criteria follows process paths that may be human or machine.

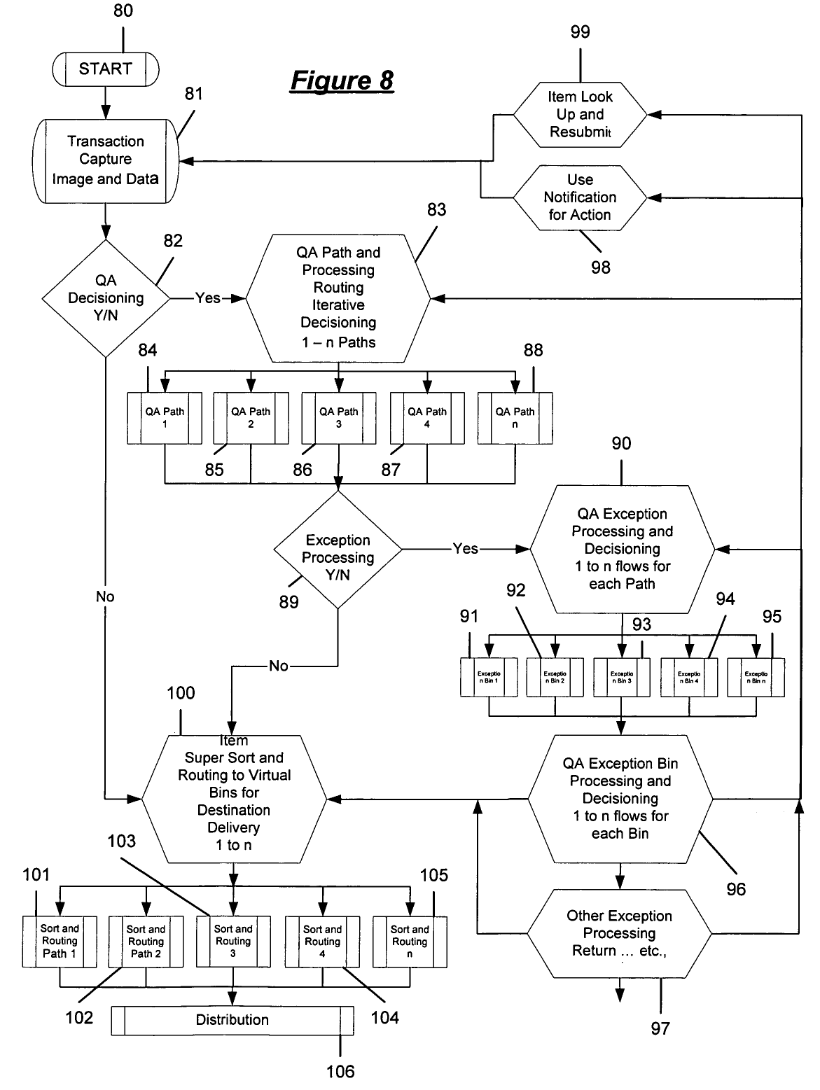

FIG. 8 charts the process from start 80 to distribution 106. At 81 transaction capture, image and data are acquired by an electronic scan or MICR read and data input. QA decisioning, Y/N, follows at 82. QA path and processing 83 involves routing and iterative decisioning along 1-n paths shown as 84 QA path 1, 85 QA path 2, 86 QA path 3, 87 QA path 4, and 88 QA path n. At 89 exception processing is determined by Y/N paths. “Yes” proceeds to 90 QA exception processing and decisioning through 1 to n flows for each path shown as 91 exception bin 1, 92 exception bin 2, 93 exception bin 3, 94 exception bin 4, and 95 exception bin n. The processed items are transmitted to 96 QA exception bin for processing and decisioning through 1 to n flows for each bin. Optionally at 97 other exception processing and return, etc. may be applied and the item is reintroduced at 98 use notification for action or 99 item look up and resubmit. If the item passes the correlation in a “No” determination, at stage 100, the item proceeds through a super sort and routing to virtual bins for destination delivery to 1 to n destinations determined by 101 sort and routing path 1, 102 sort and routing path 2, 103 sort and routing path 3, 104 sort and routing path 4, 105 sort and routing path n, and ultimately 106 distribution destination.

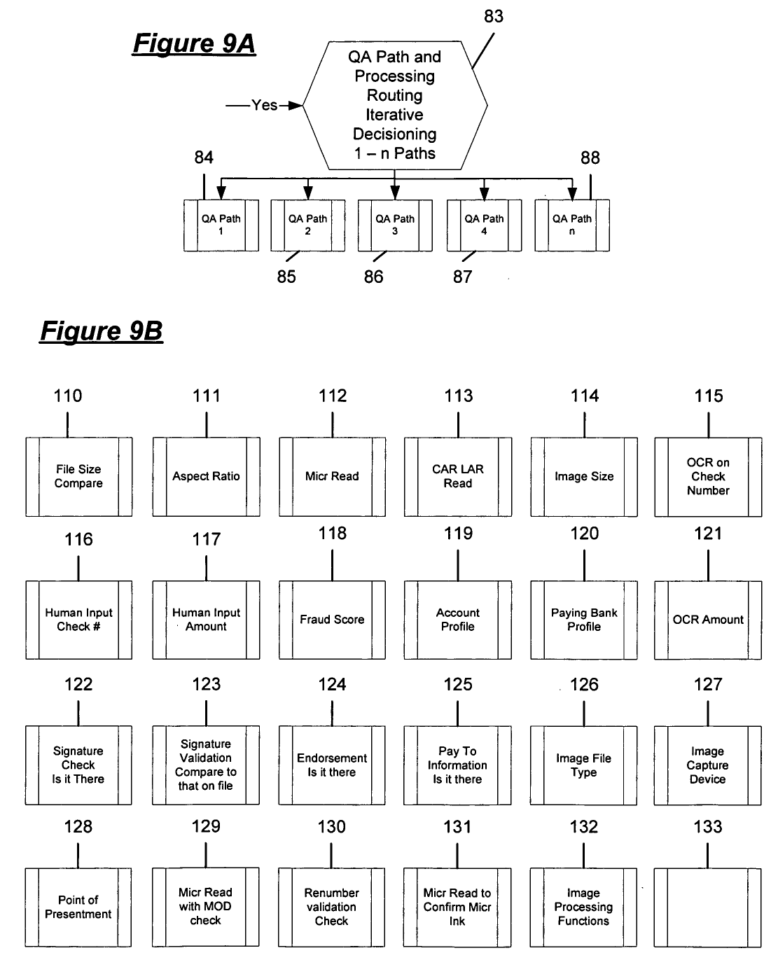

FIG. 9A shows QA path and processing routing 83 with iterative decisioning in 1-n paths depicted as 84 QA path 1, 85 QA path 2, 86 QA path 3, 87 QA path 4, and 88 QA path n. FIG. 9B lists functions or pre-stored information criteria that are elements of QA. Each QA path represents a test based on a process that includes the workflow for a set of the functions indicated. The user defines the set of functions that will be tested or evaluated for any given path. The path that is used may be based on many factors to include criteria such as point of presentment, item quality, item type, item amount, account holder, presenter, etc. The Y/N functions shown as examples are 110 file size compare, 111 aspect ratio, 112 MICR read. 113 CAR LAR read, 114 image size, 115 OCR on check number, 116 human input check number, 117 human input amount, 118 fraud store, 119 account profile, 120 paying bank profile, 121 OCR amount, 122 signature check (Is it there?), 123 signature validation (Compare to that on file.), 124 endorsement (Is it there?), 125 pay to information (Is it there?), 126 image file type, 127 image capture device, 128 point of presentment, 129 MICR read and MOD check, 130 renumber validation check, 131 MICR read to confirm MICR ink, 132 image processing functions, and 133 others.

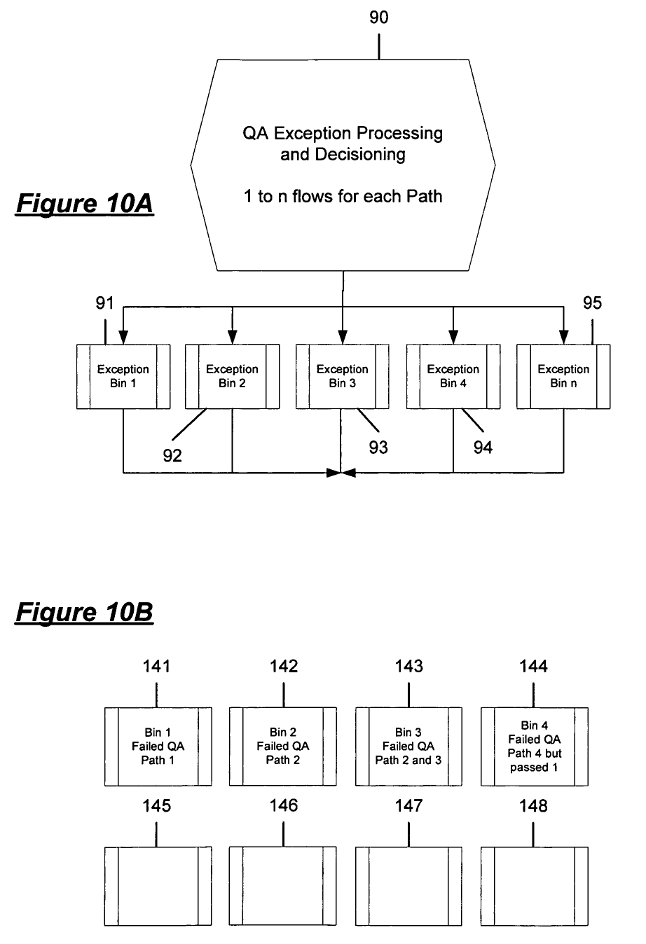

Exception processing functions and sample path definitions for decisioning are shown in FIG. 10A and FIG. 10B. In FIG. 10A, 90 indicates the QA exception processing and decisioning module having 1 to n flows for each path through 91 exception bin 1, 92 exception bin 2, 93 exception bin 3, 94 exception bin 4, and 95 exception bin n. Examples of exception processing bins are shown at 141 bin 1, failed QA path 1, at 142 bin 2, failed QA path 2, at 143 bin 3, failed QA paths 2 and 3, at 144 bin 4, failed QA path 4 but passed 1. Other combinations and permutations of Y/N QA criteria for exception processing may be included in bins 145-148, etc.

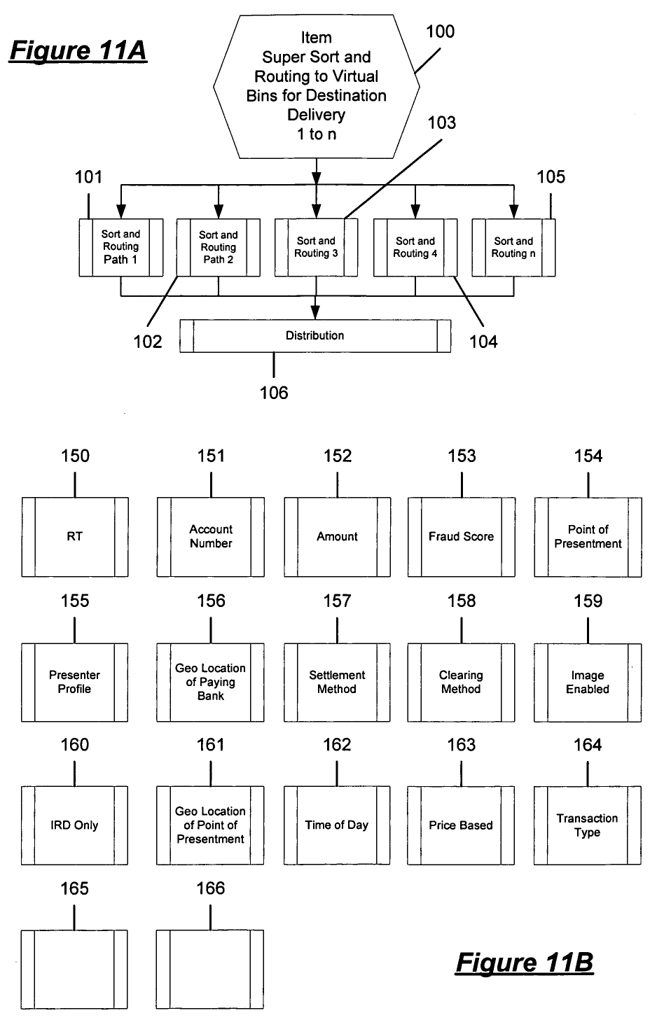

FIG. 11A shows the final item super sort and reading 100 to virtual bins for destination delivery to points 1 to n along 101 sort and reading path 1, 102 sort and reading path 2, 103 sort and routing path 3, 104 sort and routing path 4, and 105 sort and routing path n, leading ultimately to 106 distribution to a predetermined destination point. Examples of sort criteria are set out at FIG. 11B, such as 150 RT (routing/transit number), 151 account number, 152 amount, 153 fraud score, 154 point of presentment, 155 presenter profile, 156 geographic location of paying bank, 157 settlement method, 158 clearing method, 159 image enabled, 160 IRD only, 161 geographic location of point of presentment, 162 time of day, 163 price based, 164 transaction type, and 165 and 166 others.

Having thus described the invention in detail, those skilled in the art will appreciate that, given the present disclosure modifications may be made to the invention without departing from the spirit of the inventive concept herein described. Therefore, it is not intended that the scope of the invention be limited to the specific and preferred embodiments illustrated and described. Rather it is intended that the scope of the invention be determined by the appended claims.

////

////

////

////

////

////

////

////

////

////

////

////

////

1. A method for the secure and quality assured electronic end to end check processing from capture to settlement comprising:
capturing 1) check payment data and 2) an electronic image of the check and converting the paper check into a transaction data file and an associated electronic image of the check and;
optimizing the data file and image transmission over a network connection to a financial payments institution by using a data with image to follow transmission protocol determined in accordance with one or more of the bandwidth capability of the network and the criticality of the data associated with the check;
quality assuring (QA) at least one of the captured transaction data; and
associating the QA with the data and the image for the use by one or more endorsers of the check connected to one or more networks in which the check is processed.

2. The method of claim 1 in which a shared multi-function services network (SMFSN) supports real time item and batch transmission over a secure shared services network and further includes real time information retrieval, update, modification, settlement, clearing, and straight through processing among any number of defined participants, where each participant can optionally manage secure access to that participant's data independently and/or in addition to the participant's overall network privileges.

3. A method for end to end electronic check processing in accordance with claim 1 further including the dynamic management of real time data and data to follow to assure critical information is processed in the timely manner in support of straight through processing that may include real time fraud reduction, as well as near real time and/or continuous settlement.

4. A method for end to end electronic check processing in accordance with claim 1 in which the steps of check processing include image and transaction data capture; image and data transmission; the clearing and settlement of funds represented by the check; the archive of a check image; an update of aggregate payments owing to and from network participants; a retrieval index for archived checks; and an image and transaction data separation and re-integration with security, audit, QA, and non-repudiation guarantees in which adaptation and multiple exception processing paths are provided.

5. The method of claim 4 in which the multiple exception processing paths are based on one or more transaction characteristics selected from one or more of the group of: time, expense and risk associated with the transaction; the QA value associated with the transaction, the value of the transaction; the method of transmission, the origination of the transaction, destination profiles, and the type of the transaction.

6. A method for end to end electronic check processing in accordance with claim 1 in which a shared multi-function services network supports the secure transmission of electronic check data and other data over trusted and non-trusted connections in support of 1) image and transaction data capture; 2) data and image transmission; 3) settlement and clearing; 4) data and image archive; 5) data and image retrieval; 6) data and image update; 7) image and transaction separation and re-integration in the course of processing with security, audit, dynamic QA, and non-repudiation functions among a defined group of participants in which each participant can optionally manage secure access to that participant's data independently and in addition to the overall network privileges of that participant.

7. A method in accordance with claim 1 in which transitive QA for the end to end electronic check processing establishes a QA signature that is uniquely associated with a given QA process and/or transaction.

8. A method in accordance with claim 7 in which the QA process provides a signature for data and image that is uniquely associated with a QA process which may be securely communicated to any holder in due course in the processing of the check.

9. A method in accordance with claim 7 in which the QA process provides a signature for a check item or related image data that is uniquely associated with a QA process which may be securely communicated to any holder in due course in the processing of the check.

10. A method of transitive QA in accordance with claim 1 where a QA signature is created that is unique to the transaction and moves with the transaction data and image to confirm secure, quality assured tamper proof transmission, retrieval, manipulation, and storage of any or all data associated with the transaction.

11. A method of transitive QA in accordance with claim 1 where a QA signature is created that is unique to the image and moves with the image to confirm secure, quality assured tamper proof transmission, retrieval, manipulation, and storage of any or all image data associated with the transaction.

12. A method of transitive QA in accordance with claim 1 where a QA signature is created for the image and transaction data that is unique to the image and transaction data and that allows the image and transaction data to move separately and then uniquely supports the re-combining of that data to represent all elements of the complete transaction to confirm secure, quality assured tamper proof transmission, retrieval, manipulation, and storage of all data or just image data associated with the transaction.

13. A method in accordance with claim 1 in which an IRD is created and routing and distribution of the IRD distribution are based on one or more of the criteria selected from the group of: time of day, risk profile, cumulative QA, method of QA, destination point, method of transmission, cost, time of day, settlement time, settlement method, and fraud inquiry status.

14. A method in accordance with claim 1 including electronic sorting and routing of electronic check transactions in which dynamic decisioning is provided based on one or more of: source, destination, paying bank, value of item, time of day, transaction type, presentment method, QA value, QA method, level of authentication, transaction profile, cost, destination profile, geography and proximity to clearing deadlines.

15. The method of claim 1 including a transitive QA in which the recipient of data and image files receives a unique QA signature from the sender that the receiver can associate with a predetermined level of QA that has been performed on the item either by the sender or by a holder in due course that is known in the audit trail of the sender and receiver steps of transmission.

16. The method of claim 12 in which a unique QA signature is uniquely linked directly or indirectly to the transaction, sender, and QA activity.

17. The method of claim 12 including means whereby a recipient can confirm that a predetermined level of satisfactory QA has been performed with regard to data and an image and the recipient has the capability to accept a previous QA assurance and/or perform additional QA.

18. The method of claim 1 including communicating a QA value over a shared services network where the recipient may link the QA signature to a QA method and/or quality profile for the transaction.

19. The method of claim 15 in which communicating a QA value includes a step wherein the recipient may accept a communicated value as a level of QA and build on that value to arrive at an aggregate QA level that is better than that that originally received.

20. The method of claim 1 comprising a shared multi-function services network that supports secure services communication across trusted and non-trusted network connections in which QA is performed and assigned as a service from an entity on the network and available to any participant on the network or non-participant interconnected with a participant.

21. The method of claim 1 for providing a shared multi-function services network that supports secure services communication across trusted and non-trusted network connections using a WSDL services definition with security and encryption.

22. The method of claim 20 in which secure dynamic routing is performed over a shared multi-function services network to any point on the network.

23. A method of claim 1 in which the operator has the option to invoke a notification that there is no image from the point of presentment for this transaction and that the paper item associated with a transaction will follow.

24. The method of claim 20 in which secure dynamic routing is performed over a private network that may or may not be a trusted network.

25. The method of claim 20 in which secure dynamic routing is performed based on data provided by members of shared multi-function services network.

26. The method of claim 20 in which secure dynamic QA is performed based on data provided by members of a shared multi-function services network.

27. The method of claim 11 including a step of dynamic routing following QA based on one or more of the following inputs: source, destination, paying bank, network status, value of item, time of day, proximity to clearing deadlines, QA value, risk profile, and fraud indicators.

28. A method of claim 27 in which user defined virtual sort bins are defined and populated for electronic check processing and in which the transaction includes an electronic check image and/or related transaction data.

29. A method of sorting in accordance with claim 28 in which any number of user defined virtual sort bins are defined and populated for electronic check processing in which the transaction may include image only data, transaction only data, or a mix thereof.

30. A method of claim 29 including real time dynamic sorting and transmission to any number of electronic bins.

31. A method of claim 28 including electronic exception processing in which any number of user defined exception paths may be processed for electronic check processing where the transaction may include image only data, transaction only data, or any mix there of.

32. A method of claim 1 in which check image and data QA are determined by user defined QA paths and functions and is dynamically performed based on data identifying one or more of the transaction, previously performed QA, a fraud engine, the transaction destination point, information received from the transaction destination point and the data is used as a mechanism for determining one or more than one QA paths.

33. A method of claim 31 where any number of user defined exception paths and/or decisioning processes can be defined in support of dynamic QA.

34. A method of claim 31 in which real time exception processing is supported for an interactive point of presentment and communication is provided back to the point of presentment in real time for correction or item return to the customer.

35. A method of claim 1 QA is performed and an override function is supported and communicated as part of a unique signature that is associated with a transaction whereby a QA value is assigned to the transaction indicating that the operator has overridden the electronic process.

36. A method of claim 1 in which electronic check processing is performed in a parallel and separate path from paper check transaction processing.

37. A method of claim 36 where balancing is accomplished between the paper and electronic check processing paths for any specified settlement period to maintain that the bank is in balance for that period.

38. A method of claim 36 where balancing is accomplished between the paper and electronic check processing paths for any specified settlement period to maintain that the bank is in balance for that period, where there may be more than one electronic check settlement period for any given paper settlement period.

39. A method of claim 1 including a bank to bank settlement in which balancing is accomplished between the paper and electronic check processing methods for any specified settlement period to maintain that accounts of participating banks are in balance for that period.
